(19) United States
(12) Patent Application Publication
(10) Pub. No.: US 2008/0205485 A1
(43) Pub. Date: Aug. 28, 2008

(54) INSTALLATION MECHANISM FOR TEMPERATURE SENSOR

(75) Inventor: Sotoo Takahashi, Okazaki-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/039,013

(22) Filed: Feb. 28, 2008

(30) Foreign Application Priority Data
Feb. 28, 2007 (JP) 2007-049737

(51) Int. Cl. G01K 1/14

(52) U.S. Cl. 374/208; 374/E01.018

(57) ABSTRACT

An installation mechanism for installing in an outer wall of a fluid flow passage a temperature sensor equipped with a thermal sensitive device and a cylindrical casing retaining the thermal sensitive device. The installation mechanism a mount base to be joined to the fluid flow passage, an attachment to be secured to the cylindrical casing, a hollow fastener to be placed around the cylindrical casing through a gap. The fastener is designed to be rotated to press a shoulder of the attachment into constant engagement of a tapered wall thereof with a seat of the mount base to fasten the cylindrical casing to the mount base. A shield disposed to close the gap to avoid the intrusion of foreign objects into between the cylindrical casing and the fastener, thereby ensuring the removal of the fastener to dismount the temperature sensor from the fluid flow passage.

### CROSS REFERENCE TO RELATED DOCUMENT

The present application claims the benefits of Japanese Patent Application No. 2007-49737 filed on Feb. 28, 2007, the disclosure of which is totally incorporated herein by reference.

### BACKGROUND OF THE INVENTION

1. Technical Field of the Invention

The present invention relates generally to an installation mechanism for a temperature sensor working to measure the temperature of fluid, and more particularly to such a mechanism designed to ensure ease of removal of the temperature sensor from a fluid flow passage.

2. Background Art

FIG. 19 illustrates an example of one of conventional temperature sensors which is used as an exhaust gas temperature sensor to measure the temperature of exhaust gas emitted from a heat engine such as an automotive internal combustion engine.

The exhaust gas temperature sensor 500 includes a protection tube 507. A nipple 506 is disposed to be rotatable about the protection tube 507 and movable in a lengthwise direction of the protection tube 507. The nipple 506 is threadable with a boss 601 secured to an outer wall of an exhaust pipe 600 extending from the engine. The protection tube 507 has a rib 505 joined to an end thereof. The installation of the exhaust gas temperature sensor 500 in the boss 601 is achieved by placing the protection tube 507 in the boss 601, and fastening the nipple 506 into the boss 601 to bring a top end thereof into contacting abutment with the rib 505, thereby pressing the rib 505 against the inner wall of the boss 601.

When the exhaust gas temperature sensor 500 is secured to the exhaust pipe 600, it will exposed partially to outside the exhaust pipe 600 or the atmospheric air. This may cause foreign objects to intrude into a gap 514 between the inner periphery of the nipple 506 and the outer periphery of the protection tube 507, which locks the nipple 506 and the protection tube 507 together. Such locking will result in a difficulty in loosening the nipple 506 to remove the exhaust gas temperature sensor 500 from the exhaust pipe 600.

For example, Japanese Patent First Publication No. 2002-122486 discloses the above type of temperature sensor.

### SUMMARY OF THE INVENTION

It is therefore a principal object of the invention to avoid the disadvantages of the prior art.

It is another object of the invention to provide an improved structure of a temperature sensor designed to minimize mechanical vibrations transmitted thereto and ensure the durability thereof.

According to one aspect of the invention, there is provided an installation mechanism for a temperature sensor designed to install a temperature sensor in an outer wall of a fluid flow passage and ensure ease of removal of the temperature sensor from the fluid flow passage. The temperature sensor is equipped with a thermal sensitive device and a cylindrical casing which has a length and retains the thermal sensitive device. The installation mechanism comprises; (a) a mount base to be joined to the outer wall of the fluid flow passage, the mount base having a seat; (b) an attachment that is secured to the cylindrical casing of the temperature sensor and has a first and a second wall; (c) a hollow fastener which is to be placed around the cylindrical casing through a gap between an inner periphery of the hollow fastener and an outer periphery of the cylindrical casing to be rotatable about the outer periphery of the cylindrical casing and movable in a lengthwise direction of the cylindrical casing, the gap leading to outside the fastener through an opening between the fastener and the cylindrical casing, the fastener being designed to be rotated to press the first wall of the attachment into constant engagement of the second wall with the seat to fasten the cylindrical casing to the mount base so as to have the thermal sensitive device exposed to inside the fluid flow passage; and (d) a shield disposed to close at least the opening of the gap. Specifically, the shield works as a barrier or seal to block the intrusion of foreign objects into the gap between the cylindrical casing and the fastener, thereby avoiding undesirable locking of the cylindrical casing and the fastener, which ensures the ease of removal of the fastener or the temperature sensor from the fluid flow passage.

In the preferred mode of the invention, the shield is of a hollow cylindrical shape. The shield may have a flange placed in engagement with the fastener, thereby enhancing the avoidance of intrusion of foreign objects into between the cylindrical casing and the fastener and holding the body thereof from being deformed and displaced toward the thermal sensitive device when subjected to mechanical vibrations.

The shield may be disposed between the fastener and the cylindrical casing so as to occupy whole of the gap.

The shield may alternatively be disposed to occupy a portion of the gap including the opening.

The shield may be made of a collection of fibers, thereby facilitating ease of insertion of the shield into the gap through its elasticity and permitting the shield to expand elastically within the gap to enhance the degree of sealing of the gap.

The fastener may have formed therein a chamber that is a portion of the gap and exposed to the opening. The shield is at least partially fit in the chamber. This holds the body thereof from being deformed and displaced deep into the gap when subjected to mechanical vibrations.

The distance between an inner periphery of the chamber and an outer periphery of the cylindrical casing is greater than that between an inner periphery of the fastener and the outer periphery of the cylindrical casing in a portion of the gap other than the chamber. This ensures the installation of the shield with a flange.

The fastener may also have a second chamber formed in the inner periphery thereof of the chamber. The second chamber is so designed to have a diameter greater than that of the chamber. The shield is fit in both the chamber and the second chamber.

The fastener may be designed to be joined to the base mount threadably. The attachment may be made of a hollow cylinder which has an annular shoulder defining the first wall and a tapered surface defining the second wall.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partially sectional view which shows an installation mechanism for installing a temperature sensor in an exhaust pipe of an engine according to the invention;

FIG. 2 is a sectional view which illustrates a mount base secured to an exhaust pipe of an engine according to the invention;

FIG. 3 is a longitudinal sectional view which shows a temperature sensor and a portion of an installation mechanism according to the invention;

FIG. 4 is a longitudinal sectional view which shows an assembly of a fastener and a shield of an installation mechanism of the invention;

FIG. 5 is a longitudinal sectional view which represents how to assemble a shield and a fastener of an installation mechanism of the invention;

FIG. 6 is a longitudinal sectional view which shows the first modification of a shield of an installation mechanism;

FIG. 7 is a longitudinal sectional view which shows the first modification of a fastener of an installation mechanism;

FIG. 8 is a longitudinal sectional view which shows the second modification of a fastener of an installation mechanism;

FIG. 9 is a longitudinal sectional view which shows the second modification of a shield of an installation mechanism;

FIG. 10 is a longitudinal sectional view which shows the third modification of a shield of an installation mechanism which is designed to be fit in the fastener, as illustrated in FIG. 9;

FIG. 11 is a longitudinal sectional view which shows the fourth modification of a shield of an installation mechanism which is designed to be fit in the third modification of a fastener;

FIG. 12 is a longitudinal sectional view which shows a modification of the shield of FIG. 11;

FIG. 13 is a longitudinal sectional view which shows a modification of an installation mechanism which is a combination of the shield of FIG. 4 and the fastener of FIG. 11;

FIG. 14 is a longitudinal sectional view which shows a modification of the shield of FIG. 13;

FIG. 15 is a longitudinal sectional view which shows the fifth modification of a shield of an installation mechanism which is designed to be fit in the fastener of FIG. 4;

FIG. 16 is a longitudinal sectional view which shows a modification of an installation mechanism which is a combination of the shield of FIG. 15 and the fastener of FIG. 11;

FIG. 17 is a longitudinal sectional view which shows the sixth modification of a shield of an installation mechanism which is designed to be fit in the fastener of FIG. 4;

FIG. 18 is a schematic view which shows a temperature sensor of the invention which is installed in an exhaust pipe of automotive vehicle; and

FIG. 19 is a partially sectional view which shows an example of a conventional installation mechanism for installing a temperature sensor in an exhaust pipe of an engine.

### DESCRIPTION OF THE PREFERRED EMBODIMENTS

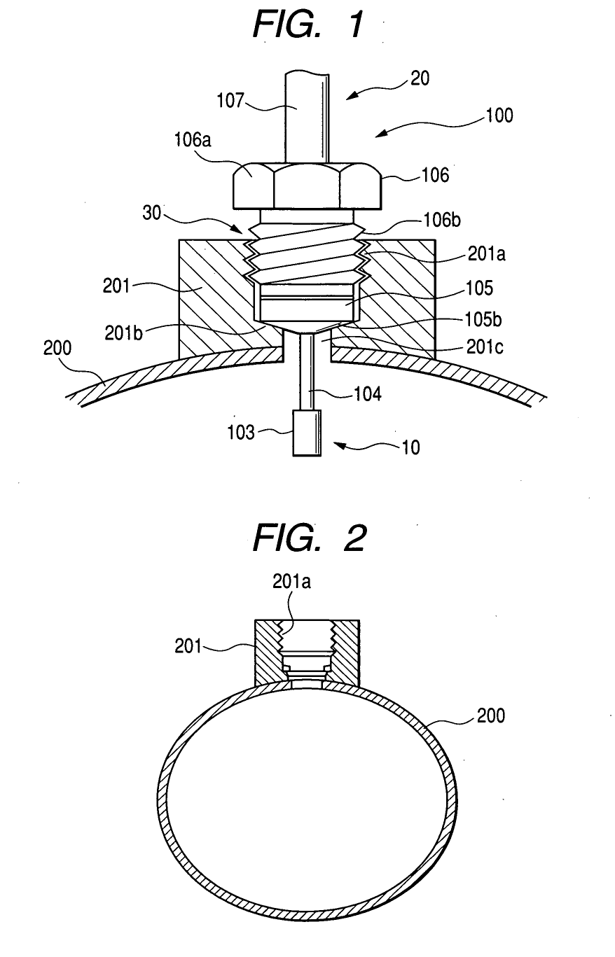

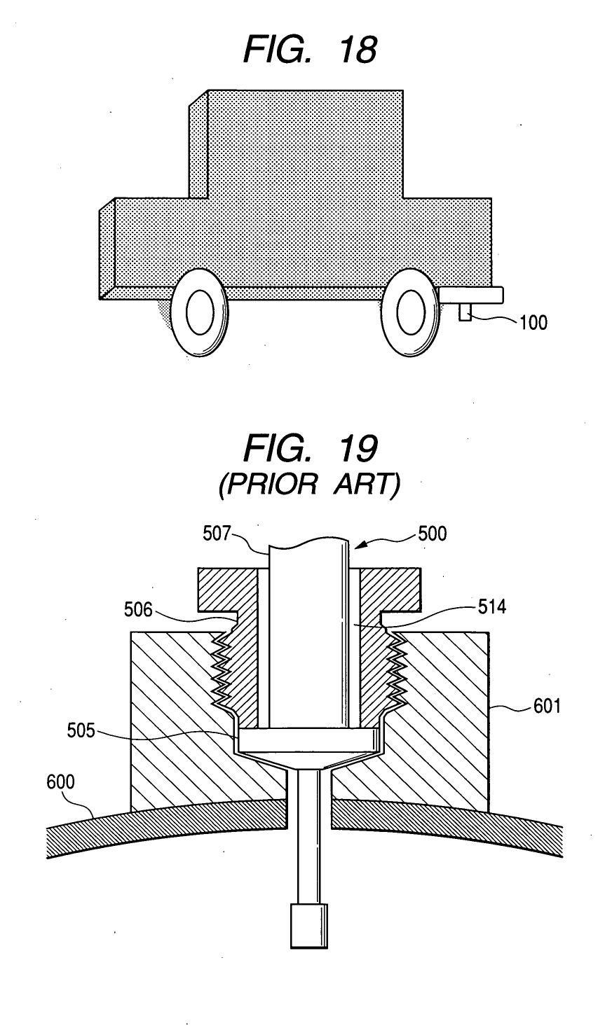

Referring to the drawings, particularly to FIGS. 1 to 3, there is shown an exhaust gas temperature sensor 1 which is to be installed in an exhaust pipe 200 of an internal combustion engine, as demonstrated in FIG. 18, to measure the temperature of exhaust emissions flowing through the exhaust pipe.

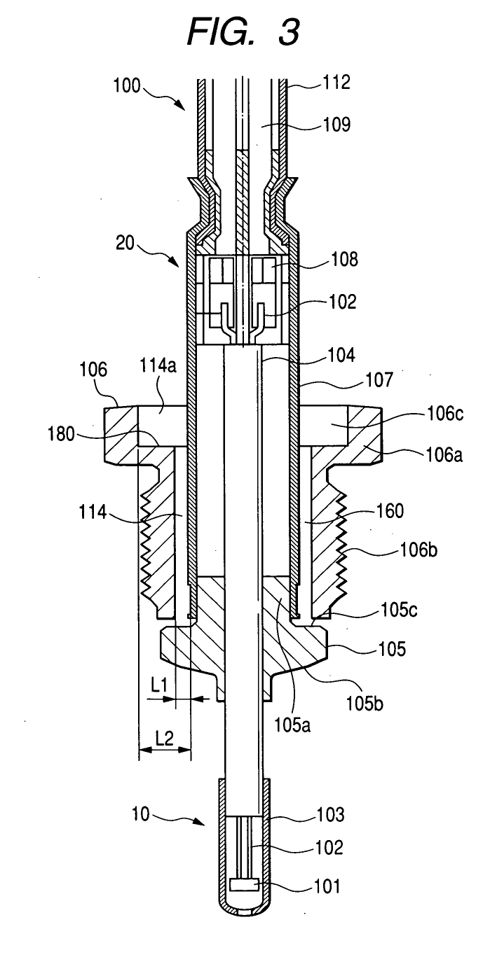

The exhaust gas temperature sensor 100, as clearly shown in FIG. 3, includes generally a thermal sensitive device 10 and a casing 20. The exhaust gas temperature sensor 100 is, as can be seen in FIG. 1, installed in the exhaust pipe 200 through a installation mechanism 30 to have the thermal sensitive device 10 exposed to the exhaust gas flowing through the exhaust pipe 200.

The thermal sensitive device 10 includes a temperature transducer 101 such as a thermistor, in-sheath pin wires 102 serving as conductors extending electrically from the temperature transducer 101, and a protective cover 103 surrounding the temperature transducer 101.

The protective cover 103 is made of a metallic hollow cylinder with a bottom. The protective cover 103 is fitted on an outer periphery of a top end of a hollow sheath pin 104. The sheath pin 104 has the in-sheath pin wires 102 disposed therein to protect them.

The thermal sensitive device 10 is coupled with the casing 20 through the sheath pin 104. The casing 20 consists of a protection tube 107 and a cylindrical attachment 105. The protection tube 107 serves as a hollow casing which has disposed therein the sheath pin 104 and connectors 108 to which the in-sheath pin wires 102 are joined.

The cylindrical attachment 105 has a center through hole and a boss 105a formed on an upper end, as viewed in FIG. 3, thereof. The protection tube 107 is made of a metallic hollow cylinder and fit on the boss 105a of the cylindrical attachment 105. The protection tube 107 is welded or brazed to the boss 105a. The sheath pin 104 is inserted into the center through hole of the attachment 105 and welded or brazed to establish a firm joint therebetween.

The connectors 108 are joined at lower ends thereof to the in-sheath pin wires 102 and at upper ends thereof to leads 109. The leads 109 are disposed at ends thereof in an upper end of the protection tube 107 and embraced by a flexible protection tube 112. The leads 109 are to be coupled electrically to a controller (not shown) to transmit a sensor output indicating the temperature of exhaust gas, as sensed by the thermal sensitive device 10, to the controller.

The installation mechanism 30 includes a nipple 106 and a boss 201. The nipple 106 serves as a fastener. The boss 201 serves as a mount base.

The nipple 106 is made of a cylindrical member with a center hole 160 which has a size enough to permit the protection tubes 107 and 112 to pass therethrough. The protection tube 107 is disposed in the nipple 106. The center hole 160 is shaped to have the inner diameter which creates an air gap 114 of a distance L1 between the inner peripheral wall of the center hole 160 and the outer peripheral wall of the protection tube 107. This permits the nipple 106 to move a longitudinal direction of the protection tube 107 and rotate within the protection tube 107. The nipple 106 has a flange 106a and an external thread 106b formed beneath the flange 106, as viewed in FIG. 3.

The boss 201 has, as clearly illustrated in FIGS. 1 and 2, an internal thread 201a formed in an inner periphery thereof which is engageable with the external thread 106b of the nipple 106. The installation of the thermal sensitive device 10 and the casing 20 of the exhaust gas temperature sensor 100 in the exhaust pipe 200 is accomplished with the installation mechanism 30.

Specifically, the installation of the exhaust gas temperature sensor 100 in the boss 201 of the installation mechanism 30, that is, the joint of the casing 20 to the boss 201 is achieved by bringing a tapered head 105a of the attachment 105 into contacting abutment with a tapered seat 201b of the boss 201, and rotating the nipple 106 relative to a shield 113, as will be described later in detail, to fasten the nipple 106 into the boss 201 while keeping the top end (i.e., the lower end, as viewed in FIG. 3) of the nipple 106 placed on a shoulder 105c (i.e., the upper end surface, as viewed in FIG. 3) of the attachment 105 until it forces the tapered head 105b against the tapered seat 201b of the boss 201. This establishes an air-tight seat on a contact between the tapered head 105 of the attachment 105 and the tapered seat 102b of the boss 201 to avoid the leakage of the exhaust gas from the hole 201c of the boss 201 to outside the installation mechanism 30.

The flange 106a of the nipple 106 has a cylindrical recess or chamber 106c opening at the upper end thereof. The chamber 106c leads to the center hole 160 and is shaped to be greater in inner diameter than the center hole 160. The chamber 106c is formed preferably by cutting or cold forging operations.

The protection tube 107 is partially disposed in the chamber 106c to define an annular gap 114a of a distance L2 between the outer periphery of the protection tube 107 and the inner periphery of the chamber 106c. The distance L2 is greater than the distance L1. The annular gap 114a opens at the upper end of the flange 106a.

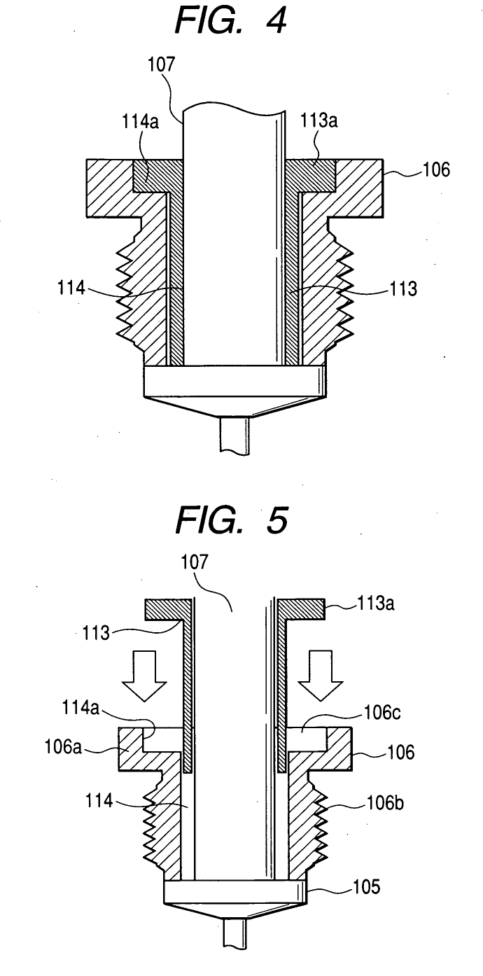

The air gaps 114 and 114a define a cylindrical chamber within which, as illustrated in FIG. 4, the shield 113 is disposed. The shield 113 is made of a hollow cylindrical body and a flange 113a formed on an end of the cylindrical body. The hollow cylindrical body occupies the whole of the air gap 114. Similarly, the flange 113a occupies the whole of the air gap 114a. The air gap 114a greater in diameter than the air gap 114 serves to facilitate ease of insertion of the shield 113 into the air gap 114.

The shield 113 is made by forming materials such as metallic, ceramic, and/or asbest-free mineral material which are high in anticorrosion, thermal resistance, and formability into fibers and waving and compressing them into a hollow flanged cylindrical body.

The installation of the shield 113, the nipple 106, and the attachment 105 on and in the exhaust gas temperature sensor 100 will be described below.

First, the shield 113 and the nipple 106 are fitted in sequence on the protection tube 107 of the exhaust gas temperature sensor 100. The attachment 105 is then joined or welded to the end of the protection tube 107.

Next, the shield 113 fit on the protection tube 107 is, as illustrated in FIG. 5, pushed toward the attachment 105. Specifically, the shield 113 is forced into the nipple 106 from the upper end thereof, as viewed in FIG. 5, toward the thermal sensitive device 10 until it occupies the gaps 114 and 114a completely. This assembly is mounted in the boss 201 to install the exhaust gas temperature sensor 100 in the exhaust pipe 200 in the manner as described above. The shield 113 is designed to permit the nipple 106 to move in the lengthwise direction of the protection tube 107 and rotate about the protection tube 107, thereby allowing the nipple 106 to be fastened into the boss 201 to install the exhaust gas temperature sensor 100 in the exhaust pipe 200. The shield 113 is, as described above, made of a collection of fibers and fit between the protection tube 107 and the nipple 106. This avoids the intrusion of foreign objects into the gaps 114 and 114a to eliminate the locking of the protection tube 107 and the nipple 106 through the foreign objects, thus settling the problem that when the nipple 106 is loosened to remove the exhaust gas temperature sensor 100 from the exhaust pipe 200, the protection tube 112 rotates following the rotation of the nipple 106 to obstruct the removal of the temperature sensor 100.

The flange 113a of the shield 113 is fitted in the chamber 106c of the nipple 106. Specifically, the flange 113a has the bottom placed or seated on an inner shoulder 180 formed in the nipple 106. The bottom has a width substantially identical with a difference between the distance L2 of the gap 114a and the distance L1 of the gap 114. This holds the shield 113 from being deformed and displaced toward the thermal sensitive device 10 when subjected to mechanical vibrations during running of the vehicle.

The location where the exhaust gas temperature sensor 100 is installed in the exhaust pipe 200 is close to the ground, so that the exhaust gas temperature sensor 100 is apt to be exposed directly to water, mud, or sands and in some instances, to snow melting agent. Further, the exhaust gas temperature sensor 100 is joined directly to the exhaust pipe 200 by screwing the nipple 106 into the boss 201 of the installation mechanism 30, so that the nipple 106 will be exposed to hot exhaust gas (e.g., 300° C. to 700° C.). Therefore, in the case of use of the exhaust gas temperature sensor 100 in automotive vehicles, it is essential for the material of the exhaust gas temperature sensor 100 to have two properties: corrosion resistance water and calcium chloride contained in the snow melting agent and heat resistance to deformation in hot environment of approximately 700° C.

The shield 113 is, as described above, made of materials such as metallic, ceramic, and asbest-free mineral material which are high in anticorrosion and thermal resistance, and thus withstands severe environmental conditions where the exhaust gas temperature sensor 100 is exposed to hot exhaust gas emitted from the automotive engine.

The shield 113 is, as described above, made of a collection of fibers or fabric, so that a total area of contact between itself and the outer periphery of the protection tube 107 or the inner periphery of the nipple 106 will be smaller as compared with the case where the shield 113 is made of metal. The shield 113 is, therefore, lower in friction within the gasp 114, thus facilitating ease of insertion of the shield 113 into the gap 114. Additionally, when the nipple 106 is removed from the boss 201 to dismount the exhaust gas temperature sensor 100 from the exhaust pipe 200, the shield 113 does not obstruct the rotation and axial movement of the nipple 106.

It is advisable that the protection tube 107, the attachment 105, and the nipple 106 be made of materials identical in coefficient of linear thermal expansion with each other in order to avoid of loosening thereof arising from the exposure to thermal shock. The shield 113 is elastic, so that effects of thermal deformation i.e., expansion and contraction thereof on other parts of the exhaust gas temperature sensor 100 are low. The shield 113 is, therefore, not necessarily made of material identical in coefficient of linear thermal expansion with that of the protection tube 107, the nipple 106, and the attachment 105 and higher in degree of freedom of choice of materials therefor.

The shield 113 is, as described above, used to seal the gaps 114 and 114a between the inner periphery of the nipple 106 and the outer periphery of the protection tube 107 completely, but however, may occupy only the gap 114a, thereby minimizing the intrusion of foreign objects into the nipple 106 sufficiently. The shield 113 may be modified as discussed below.

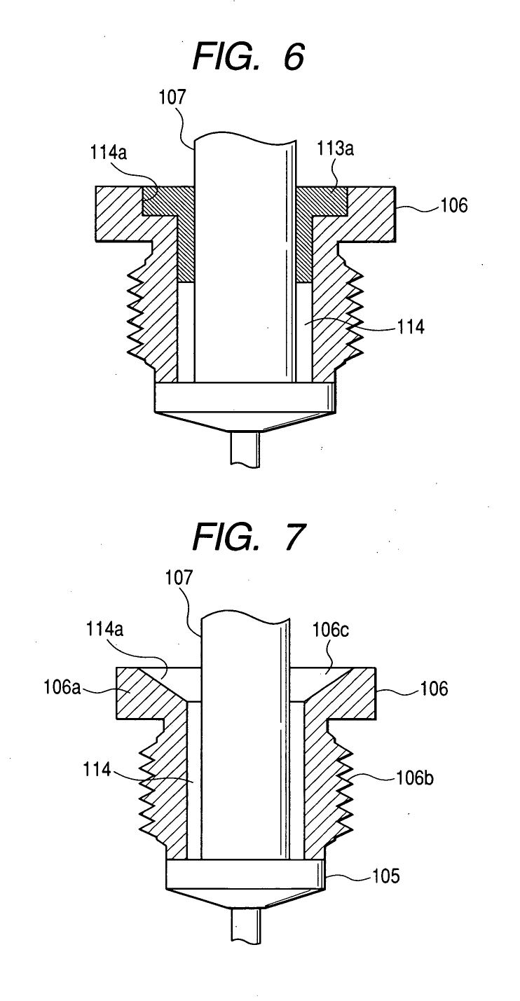

FIG. 6 illustrates the first modification of the shield 113. The shield 113 is so shaped as to occupy the air gap 114a completely, but occupy the air gap 114 partially without sealing approximately a lower half of the air gap 114.

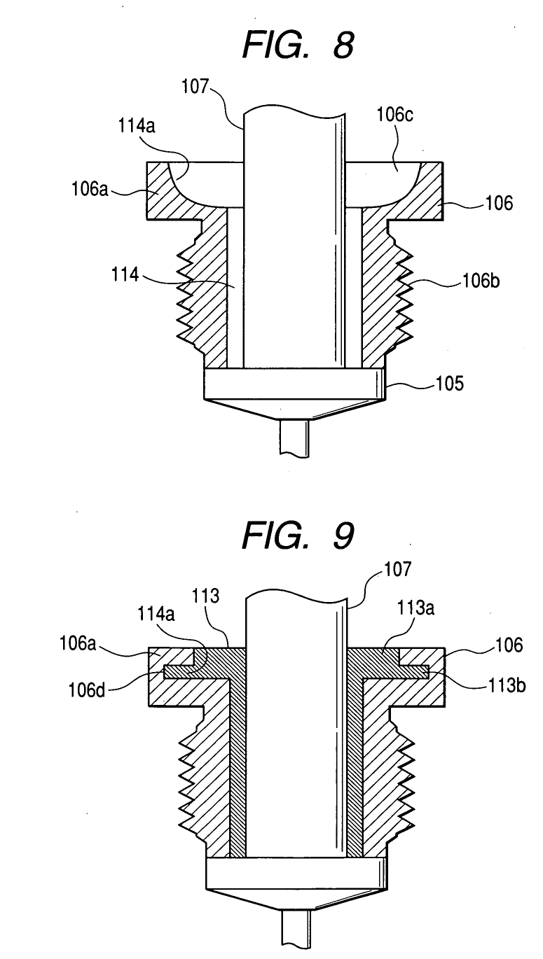

The chamber 106c formed in the nipple 106 may alternatively be, as illustrated in FIG. 7, of a frusto-conical shape in transverse section, in other words, shaped to have a tapered inner peripheral wall. The chamber 106c may also be shaped, as illustrated in FIG. 8, to have a curved inner peripheral wall. The shield 113 may be contoured to conform with the chamber 106c so as to occupy or seal the gap between the inner periphery of the nipple 106 and the outer periphery of the protection tube 107 completely. It is essential to shape the chamber 106c so that the flange 113a of the shield 113 engages the chamber 106c to stop the cylindrical body of the shield 113 from slipping deep into the air gap 114.

FIG. 9 illustrates the second modification of the shield 113. The shield 113 has the inner diameter identical with the outer diameter of the protection tube 107 and the outer diameter identical with the inner diameter of the chamber 106c. The flange 113a of the shield 113 has an annular lip 113b extending from an outer periphery thereof. The nipple 106 also has an annular chamber or groove 106d formed in the inner peripheral wall defining the chamber 106c. The lip 113b is fit in the groove 106d. Specifically, the shield 113 occupies the whole of the gap between the protection tube 107 and the nipple 106 completely. The engagement of the rip 113b with the groove 106d enhances the joining of the shield 113 to the nipple 106, thereby minimizing the dislodgement of the shield 113 from the nipple 106 when the exhaust gas temperature sensor 100 is installed on the vehicle and experiencing vertical movement due to exposure to mechanical vibrations during running of the vehicle, which ensures the blocking of entry of foreign objects into the nipple 106.

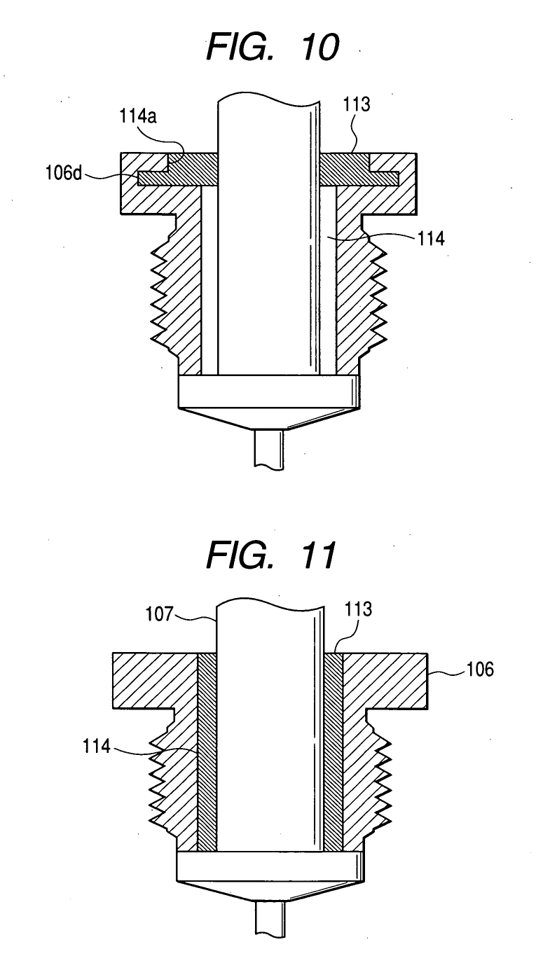

FIG. 10 illustrates the third modification of the shield 113. The shield 113 is made of an elastic disc. Specifically, the shield 113 is made to have only the flange. The nipple 106 is identical in structure with the one illustrated in FIG. 9. The shield 113 is fit in the groove 106d of the chamber 106c firmly through its elasticity. Specifically, the shield 113 is deformed to engage the groove 106d. The shield 113 may alternatively be designed, like the one in FIG. 9, to have the rip 113b.

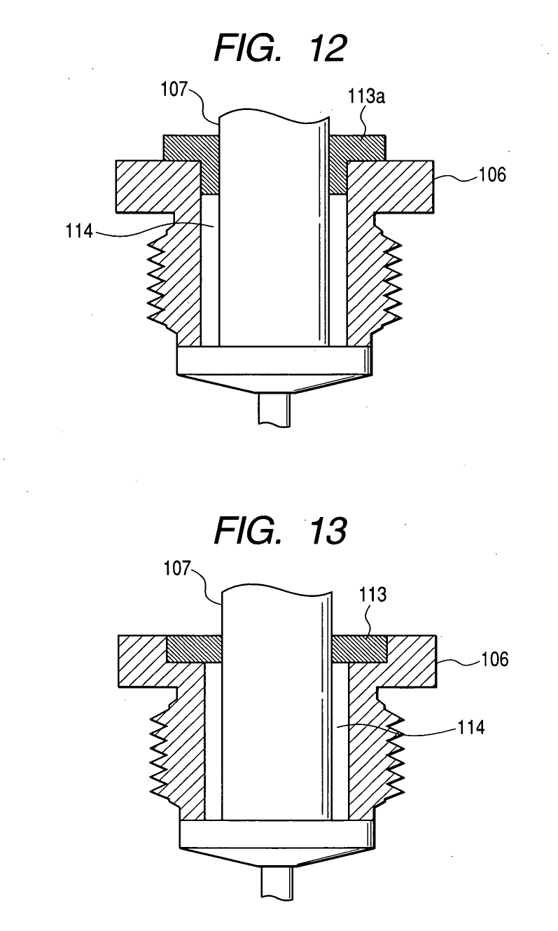

FIG. 11 illustrates the fourth modification of the shield 113. The shield 113 is made of only a hollow cylindrical body. The nipple 106 is shaped not to have the chamber 106c, as illustrated in FIG. 3, the shield 113 is fit only in the gap 114 between the protection tube 107 and the nipple 106. The shield 113 may be designed, as illustrated in FIG. 12, to seal approximately an upper half of the gap 114.

FIG. 13 illustrates a combination of the nipple 106, as illustrated in FIG. 11, and the shield 113, as illustrated in FIG. 4. Specifically, the shield 113 is fit in the gap 114 with the flange 113a placed on the upper end surface of the nipple 106.

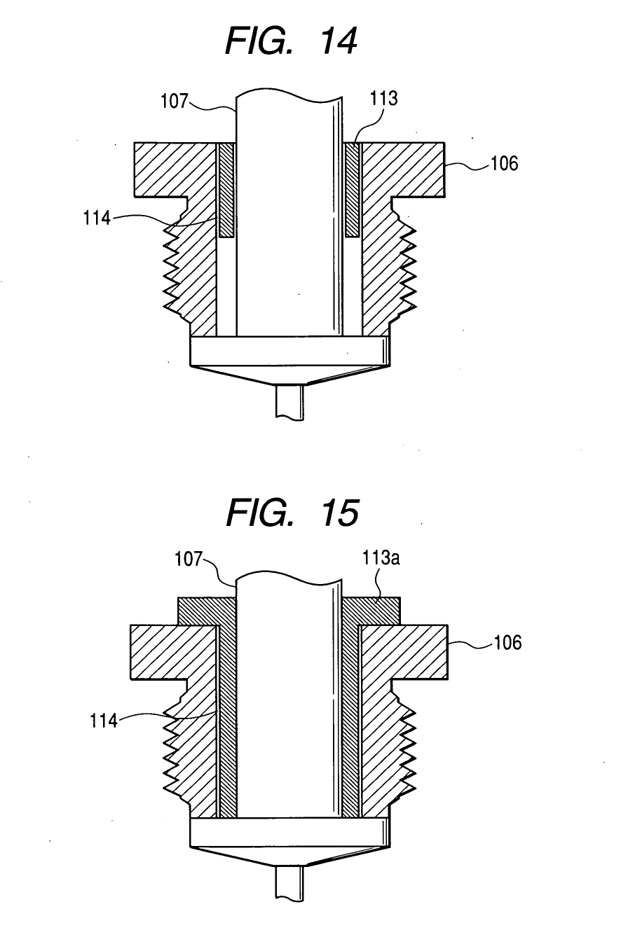

FIG. 14 illustrates a modification of the structure in FIG. 13. The shield 113 is disposed in the nipple 106 to seal approximately an upper half of the gap 114.

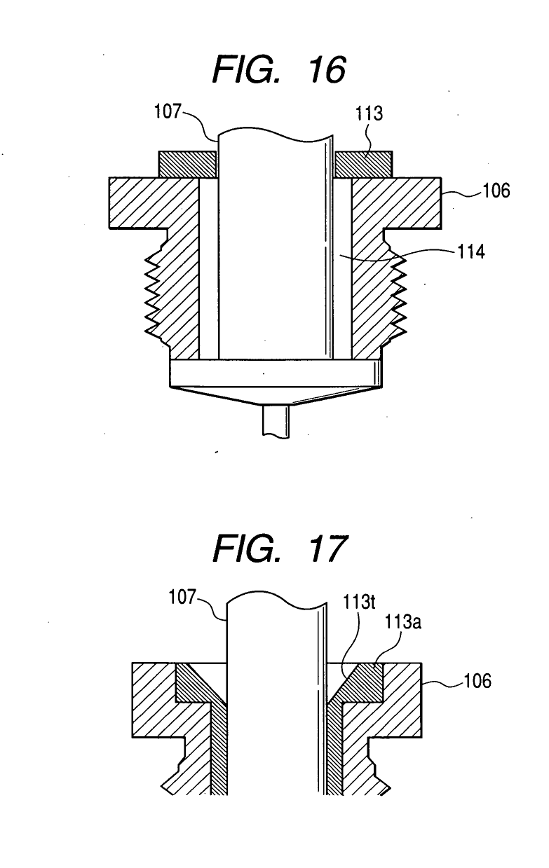

FIG. 15 illustrates the fifth modification of the shield 113. The shield 113 is made of an annular disc and fit only in the gap 114a. The nipple 106 may alternatively be shaped, as illustrated in FIG. 16, not to have the chamber 106e. The shield 113 is placed on the upper end surface of the nipple 106 to seal only an inlet (i.e. an upper end) of the gap 114 between the protection tube 107 and the nipple 106.

The nipple 106 may be designed to have two or more annular grooves, like the groove 106d in FIG. 9, formed in either or both of the inner wall defining the chamber 106c (i.e. the gap 114a) and the inner wall defining the gap 114. The grooves are shaped to extend on a plane perpendicular to the axial direction of the nipple 106.

FIG. 17 illustrates the sixth modification of the shield 113. The flange 113a of the shield 113 has an inner tapered surface 113t facing the periphery of the protection tube 107. The shield 113 is, as described above, made of an assembly of fibers or fabric and thus deformed due to the insertion thereof into the nipple 106, so that the inner diameter thereof becomes slightly smaller than the outer diameter of the protection tube 107. This may interfere with the insertion of the protection tube 107 into the shield 113 to increase a difficulty in assemble the protection tube 107 and the nipple 106 together. The inner tapered surface 113t eliminates such a drawback and facilitates ease of the insertion of the protection tube 107 into the shield 113.

While the present invention has been disclosed in terms of the preferred embodiments in order to facilitate better understanding thereof, it should be appreciated that the invention can be embodied in various ways without departing from the principle of the invention. Therefore, the invention should be understood to include at possible embodiments and modifications to the shown embodiments which can be embodied without departing from the principle of the invention as set forth in the appended claims.

What is claimed is:

1. An installation mechanism for installing in an outer wall of a fluid flow passage a temperature sensor equipped with a thermal sensitive device and a cylindrical casing which has a length and retains the thermal sensitive device) comprising:
a mount base to be joined to the outer wall of the fluid flow passage, said mount base having a seat;
an attachment that is secured to the cylindrical casing of the temperature sensor and has a first and a second wall;
a hollow fastener which is to be placed around the cylindrical casing through a gap between an inner periphery of said hollow fastener and an outer periphery of the cylindrical casing to be rotatable about the outer periphery of the cylindrical casing and movable in a lengthwise direction of the cylindrical casing, the gap leading to outside said fastener through an opening between said fastener and the cylindrical casing, said fastener being designed to be rotated to press the first wall of said attachment into constant engagement of the second wall with the seat to fasten the cylindrical casing to said mount base so as to have the thermal sensitive device exposed to inside the fluid flow passage; and
a shield disposed to close at least the opening of the gap.

2. An installation mechanism as set fort in claim 1, wherein said shield is of a hollow cylindrical shape.

3. An installation mechanism as set forth in claim 2, wherein said shield has a flange placed in engagement with said fastener.

4. An installation mechanism as set forth in claim 1, wherein said shield is disposed between said fastener and the cylindrical casing so as to occupy whole of the gap.

5. An installation mechanism as set forth in claim 1, wherein said shield is disposed to occupy a portion of the gap including the opening.

6. An installation mechanism as set forth in claim 1, wherein said shield is made of a collection of fibers.

7. An installation mechanism as set forth in claim 1, wherein said fastener has formed therein a chamber that is a portion of the gap and exposed to the opening, and wherein said shield is at least partially fit in the chamber.

8. An installation mechanism as set forth in claim 7, wherein a distance between an inner periphery of the chamber and an outer periphery of the cylindrical casing is greater than that between an inner periphery of said fastener and the outer periphery of the cylindrical casing in a portion of the gap other than the chamber.

9. An installation mechanism as set forth in claim 8, wherein said fastener also has a second chamber formed in the inner periphery thereof of the chamber, and wherein the second chamber is so designed to have a diameter greater than that of the chamber.

10. An installation mechanism as set forth in claim 8, wherein said shield is fit in both the chamber and the second chamber.

11. An installation mechanism as set forth in claim 1, wherein said fastener is designed to be joined to the base mount threadably.

12. An installation mechanism as set forth in claim 1, wherein said attachment is made of a hollow cylinder which has an annular shoulder defining the first wall and a tapered surface defining the second wall.
